(19) United States
(12) Patent Application Publication
(10) Pub. No.: US 2024/0367182 A1
(43) Pub. Date: Nov. 7, 2024

(54) ROTOR AND CENTRIFUGE USING SAME

(71) Applicant: Eppendorf Himac Technologies Co., Ltd., Ibaraki (JP)

(72) Inventors: Mamoru Kanehama, Ibaraki (JP); Takato Komura, Ibaraki (JP); Hiroatsu Toi, Ibaraki (JP); Eiichi Fukuhara, Ibaraki (JP)

(73) Assignee: Eppendorf Himac Technologies Co., Ltd., Ibaraki (JP)

(21) Appl. No.: 18/580,158

(22) PCT Filed: Aug. 30, 2022
(86) PCT No.: PCT/JP2022/032501

§ 371 Date: Jan. 18, 2024

(30) Foreign Application Priority Data
Aug. 31, 2021 (JP) 2021-140741

(51) Int. Cl. B04B 7/08; B04B 1/02; B04B 11/02

(52) U.S. Cl. CPC B04B 7/08; B04B 1/02; B04B 11/02

(57) ABSTRACT

A rotor for a continuous centrifugal separator includes a core body in a substantially cylindrical shape, fins, and a rotor body in a tubular shape. The core body is formed with fin mounting grooves continuous in an axial direction on an outer circumferential surface. The fins are mounted to protrude to a radially outer side from an outer circumferential surface of the core body. As the fin to be mounted, multiple types of fins that have different circumferential widths of a portion protruding to the radially outer side from the outer circumferential surface of the core body are prepared. A volume of centrifugal separation spaces is changeable by an operator selecting any one of the multiple types of fins and mounting the fins to the core body.

### TECHNICAL FIELD

The present invention relates to a centrifuge that flows a sample during rotation of a rotor to centrifugally separate particles in the liquid sample within the rotor.

### RELATED ART

The centrifuge is a device separating, by a centrifugal force, particles that do not settle or are difficult to settle in a normal gravitational field. Examples of a separation target include virus and bacterial body. Virus and bacterial body are indispensable raw materials for the production of chemicals and vaccines, and in their production processes, a so-called continuous centrifugal separator is widely used as a device for separating and refining raw materials. The continuous centrifugal separator has a sample supply part for enabling continuous supply of a sample to a rotor rotating at high speed. The sample supply part has a liquid delivery pump for supplying the sample and, under control of a control device, continuously supplies the sample from an inlet of the rotor to inside of the rotor and discharges the sample from an outlet of the rotor during rotation of the rotor.

In a centrifuge, the rotational speed (revolutions per minute (rpm)) of the motor that rotates the rotor is determined, and by rotating the rotor at this rotational speed for a determined time with the sample introduced into the rotor, a strong centrifugal force is applied to the sample inside the rotor. The acceleration (centrifugal acceleration) at this time may be tens of thousands of G or more in units of gravitational acceleration G. Because the rotational speed of the rotor is high, the rotor is often provided in a vacuum-exhausted rotor chamber. After the centrifugal separation process, the sample is separated according to the density.

In the case of using such a centrifuge to centrifugally separate a sample which is a raw material of a vaccine, for example, a portion corresponding to the desired density is selectively extracted after centrifugal separation is performed. A configuration of such a continuous centrifugal separator is described in Patent Document 1, for example. Herein, with reference to FIG. 10, the shape of a core body 331 of a conventional rotor disclosed in Patent Document 1 will be described. FIG. 10(A) is a top view of the core body 331 and fins 340. In the continuous centrifugal separator of Patent Document 1, the fin 340 is configured separately from the core body 331 for the purpose of suppressing fixation between the rotor body 311 (see (B) for reference sign) and the core body, and each fin 340 is mounted to the core body 331. The shape after mounting the fins 340 has an appearance similar to the shape of a rotor core of a conventional centrifuge prior to Patent Document 1 and is the same as the shape in which fins are integrally formed with the core body. Fin mounting grooves 337 are formed on the core body 331. The fin 340 has a fin tip part 342, is attached with a fin base part 341 inserted into the fin mounting groove 337, and is slightly movable in the radial movement.

FIG. 10(B) is a view showing a state of the fin 340 when the rotor is rotating at high speed. During the centrifugal separation process, the rotor body 311 slightly expands due to a centrifugal force, but at the same time, the fin 340 also moves outward due to the centrifugal force, so the tip (radial outer circumferential surface) of the fin tip part 342 becomes abutted against the inner surface of the rotor body 311. A movable range 345 of the fin 340 at this time is, for example, about 0.1 mm to 0.5 mm. No precipitate P enters between the tip part of the fin tip part 342 and the inner surface of the rotor body 311, each centrifugal separation space S is maintained in a sealed state by the fins 340, and turbulence in the sample (liquid) in the separation space S is suppressed.

In the state of FIG. 10(C) in which rotation of the rotor has stopped from the above state, the rotor body 311 slightly contracts from the state of FIG. 10(B), but during this contraction, the fin 340 moves inward while the fin tip part 342 abuts against the inner surface of the rotor body 311. As a result, from the time of the centrifugal separation process to the end of the process, the contact state between the tip part of the fin 340 and the inner surface of the rotor body 311 is maintained. During disassembly of the rotor, the fin 340 is movable in the rotation axis direction (up-down direction). Thus, after the end of the centrifugal separation operation, the sample (liquid) after the precipitate P is separated in the centrifugal separation space S is removed in an order reverse to that of sample introduction, and the rotor is disassembled. At the time of this disassembly, the lower rotor cover (not shown) of the rotor is removed, and with the core body 331 mounted on the rotor body 311, a user can move the fins 340 downward to remove the fins 340 from the core body 331. Afterwards, the upper rotor cover is separated from the core body 331, and the rotor can be easily disassembled.

### RELATED ART DOCUMENTS

### Patent Documents

Patent Document 1: Japanese Patent Application Laid-Open No. 2017-131873

Patent Document 2: Japanese Patent Application Laid-Open No. 2006-43618

### SUMMARY OF INVENTION

### Problem to Be Solved by Invention

In a continuous centrifugal separator, a preliminary test for finding the optimal conditions of continuous centrifugal separation for production may be realized by changing and scaling down a part of the actual continuous centrifugal separator for production. In that case, depending on the amount of sample to be separated, it is necessary to prepare multiple cores or centrifuges, and it is necessary to provide introduction costs and an installation location of the multiple centrifuges. Also, in the art of Patent Document 2, in addition to a standard core body accommodated inside the rotor body, a small-volume core body is prepared. However, preparing a small-volume core body becomes a factor in cost increase, and even if a small-volume core body has been prepared, in the case where the depth of the flow path in the radial direction is different between a core (core for a preliminary test) that separates a small amount of sample and a core (core for production) that separates a large volume of sample, the time required for sample separation will differ. Thus, it is necessary to adjust the flow rate at which the sample is fed into the rotor. Also, based on the operating conditions of the core (core for the preliminary test) that separates a small amount of sample, the operating conditions are obtained for the core (core for production) that separates a large volume of sample according calculation. In some cases, fine adjustment of the operating conditions is necessary, and it takes time and effort to find the optimal conditions.

The present invention has been made in view of the above background, and an objective thereof is to provide a rotor for a centrifuge that configures a fin part of a core body to be capable of being attached and detached and configures a volume of a centrifugal separation space to be switchable in stages according to the size of the fin to be mounted, and a centrifuge using the rotor.

Another objective of the present invention is to provide a rotor for a centrifuge that makes it possible to change a volume of a centrifugal separation space while maintaining the same centrifugal operating conditions, and a centrifuge using the rotor.

Still another objective of the present invention is to provide a rotor for a centrifuge that makes it possible to change a volume of a centrifugal separation space by a simple method while using a common rotor body and a common core body, and a centrifuge using the rotor.

### Means for Solving Problem

Representative features of the invention disclosed in this application are as follows.

According to a feature of the present invention, a rotor for a centrifuge includes a core and a rotor body in a tubular shape. The core includes a core body in a columnar shape and a plurality of fins mounted to the core body to protrude in a radial pattern from an outer circumferential surface of the core body. The rotor body surrounds the core. The rotor is configured such that a sample is flowed to the core body and inside the rotor body between both end sides in a direction of a rotation axis, and the rotor rotates around the rotation axis. The fin is capable of being attached and detached with respect to the core body. As the fin, a plurality of types of fins that have different circumferential widths of a portion protruding to a radially outer side from the outer circumferential surface of the core body are prepared. During disassembly of the rotor, a user selects any one of the plurality of types of fins and mounts the fins to the core body, so that a volume of a centrifugal separation space S defined between the core body and the rotor body can not only correspond to a general size, but the volume can also be reduced to correspond to small-volume centrifugal separation. The core body of the rotor has a substantially cylindrical shape, and a plurality of fin mounting grooves are formed at equal intervals in a circumferential direction on the outer circumferential surface of the core body. The fin mounting groove is continuously formed from an upper end to a lower end of the core body in a direction parallel to the rotation axis of the rotor. The fin is formed of an attachment part having a shape corresponding to the fin mounting groove and a protruding part protruding to the radially outer side from an opening surface of the fin mounting groove. A circumferential width of the protruding part is formed to be larger than a width of the fin mounting groove.

According to another feature of the present invention, the protruding part of the fin is formed with an inner circumferential surface in contact with the outer circumferential surface of the core body and an outer circumferential surface in contact with an inner circumferential surface of the rotor body, and an area of the outer circumferential surface of each of the fins is configured to be larger than an opening area of the fin mounting groove. The sample to be centrifugally separated in the centrifuge is injected into the rotor body from one side in the direction of the rotation axis and discharged from another side in the direction of the rotation axis during rotation of the rotor, and the fins and the core body are removable from the rotor body during disassembly of the rotor. Further, since a radial distance of the centrifugal separation space S between inside of the rotor body and the core is constant regardless of the fin selected by the user, changes such as a change in the centrifugal acceleration applied to the sample do not occur even if the fin is changed, and the centrifugal separation conditions remain constant. The core body and the fin are made of synthetic resin or metal, and a density of the fin is configured to be smaller than a density of the core body. For example, if the density of the fin is set as less than 1.2 g/cm³ to be smaller than a maximum density of the density gradient liquid, upon performing centrifugal separation while flowing the sample into the rotor, the fin moves in a direction approaching the rotation axis due to a density difference with respect to the sample.

According to still another feature of the present invention, a rotor in a centrifuge is provided, the centrifuge including: the rotor in a cylindrical shape for separating a sample; a centrifuge chamber in which the rotor is accommodated; a drive device that rotates the rotor; and a sample line that continuously supplies and discharges the sample to and from the rotor during rotation of the rotor. The rotor is composed of: a rotor body in a cylindrical shape; a core body that forms a path of the sample by being arranged in the rotor body: and a fin capable of being attached to and detached from the core body to divide an inside of the rotor body into a plurality of spaces to separate the sample. The core body is formed with a fin mounting groove for attaching the fin. The fin is formed to include an attachment part in a shape corresponding to the fin mounting groove and a protruding part protruding to a radially outer side from the fin mounting groove, and a volume of a centrifugal separation space between the core body and the rotor body is changeable by extending the protruding part in a circumferential direction of the rotor beyond a forming range of the fin mounting groove. The protruding part of the fin includes an arc surface having an outer surface with an outer diameter substantially equal to an inner diameter of the rotor body, an inner surface of the protruding part is formed as an arc surface in contact with an outer surface of the core body, and a density of the fin is configured to be smaller than a density of the core body. Using such a rotor, a continuous centrifuge including a drive part that drives the rotor is formed.

### Effects of Invention

According to the present invention, the blade part (fin) is configured to be capable of being attached to and detached from the body (core body) of the rotor core, and a general blade part and a blade part for making the centrifugal separation space smaller than usual are prepared. By exchanging the blade part mounted to the body, a user can change the volume of the separation space (separation chamber) by changing the flow path area of the centrifugal separation space (separation chamber) without changing the radial distance of the separation space. As a result, it is possible to flexibly respond to a change in processing volume of a one-time centrifugal separation operation; for example, it is possible to cope with continuous centrifugal separations from a small-volume test to a large-volume production. Thus, there is no need to prepare multiple core bodies or rotors. In addition, since the flow path volume can be changed by simply replacing the blade part without changing the radial dimension of the body (core body) of the rotor core, it is possible to flexibly respond to a change in sample volume while keeping the centrifugal conditions unchanged. In this manner, optimal operating conditions can be derived with a small amount of test sample, and the sample for production (large volume) can be separated without changing the operating conditions. As a result, it is possible to flexibly respond to a change in processing volume of a one-time centrifugal separation operation; for example, it is possible to cope with separations from a test separation to a separation for production. Thus, there is no need to prepare multiple cores or continuous centrifuge bodies. In addition, since the flow path area can be changed by simply replacing the blade part without changing the radial dimension of the body (core body) of the rotor core, it is possible to eliminate the risk that centrifugal conditions would change due to changes in the volume of sample. In this manner, optimal operating conditions can be derived with a small amount of test sample, and the sample for production (large volume) can be separated without changing the operating conditions.

### BRIEF DESCRIPTION OF DRAWINGS

FIG. 1 is a perspective view showing an entirety of a centrifuge 1 according to an embodiment of the present invention.

FIG. 2 is a cross-sectional view showing a detailed structure of a centrifugal separation part 100 in FIG. 1, and is a piping diagram of a sample line.

FIG. 3 is a longitudinal sectional view of a rotor 10 in FIG. 1.

FIG. 4 is a cross-sectional view of an A-A part in FIG. 3. (A) is a cross-sectional view of a state in which a standard fin 40 is attached to a core body 31. (B) is a view for illustrating an attachment method of the fin 40 or a fin 50 received by the core body 31, and (C) is a cross-sectional view of the A-A part in which a fin 50 adapted for a small volume is attached to the core body 31.

FIG. 5(A) is a top view of a state in which the fin 50 adapted for a small volume is attached to the core body 31 of this embodiment, (B) is a partially enlarged view of (A), and (C) is a partial top view of a state in which a fin 60 adapted for a medium volume is attached to the core body 31.

FIG. 6(A) is a perspective view showing an overall shape of the standard fin 40 shown in FIG. 4, (B) is a perspective view showing an overall shape of the fin 50 for a small volume shown in FIG. 4, and (C) is a horizontal sectional view (schematic view) for illustrating a state of the fin 50 for a small volume when the rotor is rotated at high speed.

FIG. 7 is a view showing a fin 70 for a small volume according to a first modification example of this embodiment, (A) is a horizontal sectional view, and (B) is a perspective view showing an entirety.

FIG. 8 is a view showing a fin 80 for a small volume according to a second modification example of this embodiment, (A) is a horizontal sectional view, and (B) is a perspective view showing an entirety.

FIG. 9 is a vertical sectional view of a rotor 10A according to a second embodiment of the present invention.

FIG. 10 (A) is a top view showing a shape of a core body 331 of a conventional rotor, (B) is a view showing a state of fins 340 when the rotor is rotating at high speed, and (C) is a view showing a state of the fins 340 when the rotor decelerates and stops.

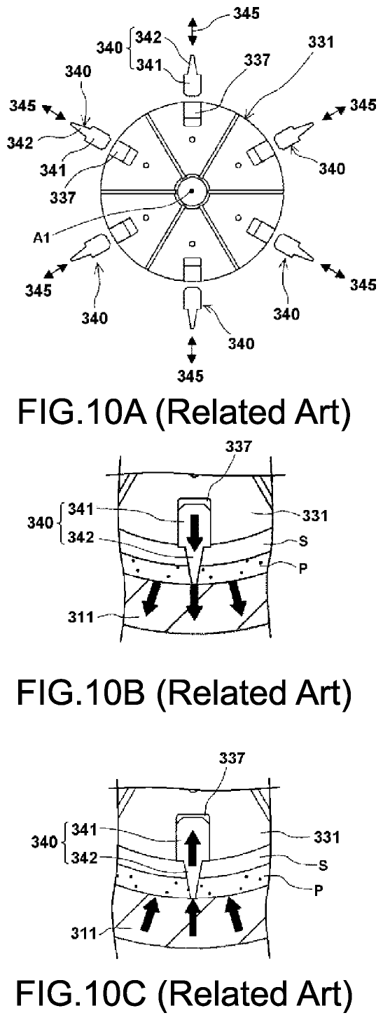

### DESCRIPTION OF EMBODIMENTS

### Embodiment 1

The embodiments of the present invention will be described below based on the drawings. In the following figures, the same parts are labeled with the same reference signs, and repeated descriptions will be omitted. Also, in this specification, the front, rear, up, and down directions will be described as shown in the figures.

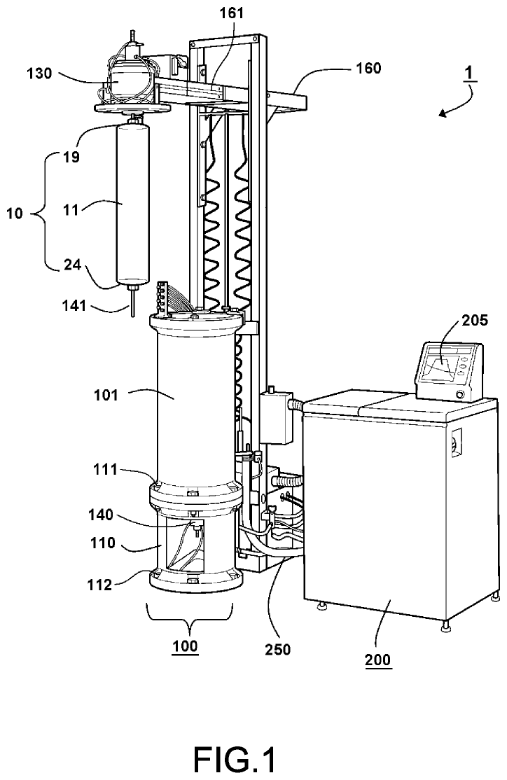

FIG. 1 is a perspective view showing an entirety of a centrifuge (continuous centrifugal separator) 1 according to this embodiment. As shown in FIG. 1, a centrifuge 1 is capable of continuously supplying a sample from outside to inside of a rotor 10 and discharging the sample during rotation of the rotor 10, and the centrifuge 1 is widely used in processes such as vaccine manufacturing. The centrifuge 1 is composed of two main portions including a centrifugal separation part 100 and a control device part 200. The centrifugal separation part 100 and the control device part 200 are connected to each other by a wiring and piping group 250.

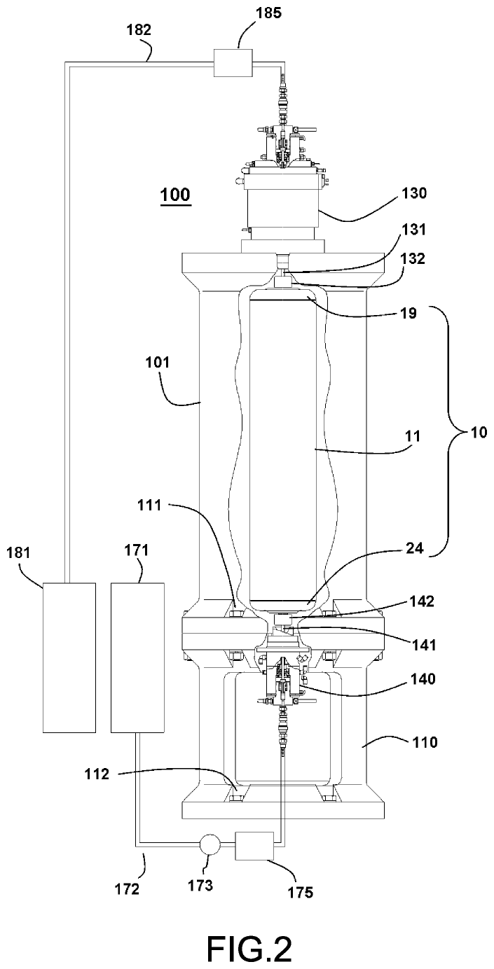

The centrifugal separation part 100 includes a chamber 101 in a cylindrical shape that serves as a centrifugal chamber, a base 110 that supports the chamber 101, a rotor 10 that is accommodated inside the chamber 101 in a manner being freely taken in and out and rotates at high speed, a drive part 130 that is arranged on the upper side of the chamber 101 and drives rotation of the rotor 10 in a suspended state, a lower rotation support part 140 that is attached to the lower side of the chamber 101, a lift 160 and an arm 161 that serve to move the drive part 130 in up-down and front-rear directions, and a sample line (to be described later with reference to FIG. 2) that continuously supplies and discharges a sample or a sterilizing liquid to and from the rotor 10. The rotor 10 is composed of a rotor body 11 in a cylindrical shape, an upper rotor cover 19 that is attached by screwing to the upper side of the rotor body 11, and a lower rotor cover 24 that is attached by screwing to the lower side of the rotor body 11. A lower shaft 141 is connected to the lower rotor cover 24, and accordingly a rotating container that rotates at high speed is formed.

The rotor 10 is driven to rotate at high speed, and to suppress heat generation resulting from frictional heat and wind loss with the atmosphere during operation, the inside of the chamber 101 is kept in a pressure-reduced state during the centrifugal separation operation. To create the pressure-reduced state inside the chamber 101 in which the rotor 10 is accommodated, an exhaust port (not shown) that discharges air from inside the chamber 101 is formed at the body of the chamber 101, and a vacuum pump (not shown) is connected. The chamber 101 is fixed to the base 110 with a plurality of bolts 111, and the base 110 is fixed to the floor surface with a plurality of bolts 112.

The control device part 200 accommodates a cooling device (not shown) for cooling the entire centrifugal chamber inside the chamber 101, a vacuum pump (not shown) for creating a pressure-reduced state of the centrifugal chamber inside the chamber 101, a lift drive device (not shown) that drives the lift 160 and the arm 161 to move the rotor 10 to a predetermined location, and a control device (not shown) that controls driving of the rotor 10. The control device is composed of an electronic circuit including a microcomputer (not shown) and a storage device (not shown), and performs rotation control on the rotor 10 as well as control on the entirety of devices included in the centrifuge 1. An operation panel 205, which serves both functions of an input part for a user to input information and a display part for displaying operating statuses to the user, is arranged on the upper part of the control device part 200. The operation panel 205 may be, for example, a liquid crystal display device of a touch sensor type, and an audio output part such as a speaker (not shown) may also be provided together.

FIG. 2 is a cross-sectional view showing a detailed structure of the centrifugal separation part 100 in FIG. 1. The chamber 101 accommodates therein the rotor 10 suspended at the drive part 130, and an evaporator (not shown) is arranged to cover around the rotor 10. The evaporator is composed of a copper piping that circulates a refrigerant gas to thereby cool the inside of the chamber 101 at a set temperature.

The drive part 130 is composed of a motor (not shown). When performing centrifugal separation, a sample is injected from the lower shaft 141 side into the rotor 10, and the sample introduced into the rotor 10 is moved to a high centrifugal field (a centrifugal separation space S to be described later) by the core 30 to be described later, and is separated into a precipitate and a supernatant. The supernatant (waste liquid) is discharged from a sample passage hole of the upper shaft 131.

The motor has a hollow rotating shaft (upper shaft 131) extending in the up-down direction, the upper rotor cover 19 is fixed to the lower end side of the upper shaft 131 by a nut 132, and the rotor 10 rotates in a form suspended from the drive part 130. The lower shaft 141, which is a rotating shaft part, is attached to the lower rotor cover 24 by a nut 142. Through holes (sample passage holes), which are an upper passage and a lower passage, pass through the respective centers of the rotating shafts of the upper shaft 131 and the lower shaft 141, and these sample passage holes communicate with sample passage holes formed at each of the upper rotor cover 19 and the lower rotor cover 24. Due to high-speed rotation of the upper shaft 131 driven by the motor included in the drive part 130, the rotor 10 attached to the upper shaft 131 rotates at high speed together with the lower shaft 141. The lower shaft 141, which rotates along with the rotor 10, is axially supported by the lower rotation support part 140. The lower rotation support part 140 is fixed at a position of the base 110 that abuts against the chamber 101.

The sample is supplied from a sample tank 171 and flows into the rotor 10 through a lower connecting pipe 172, a liquid delivery pump 173, a mass flow meter 175, the lower rotation support part 140, and the lower shaft 141. When a sample is put into the sample tank 171 and the liquid delivery pump 173 is operated to start sample supply from the lower connecting pipe 172 to the rotor 10 through the lower shaft 141, the inside of the rotor 10 is gradually filled with the sample. When the inside of the rotor 10 is full of the sample, the overflowed liquid is sent out to the upper connecting pipe 182 through the upper shaft 131 and the drive part 130, and discharged into a supernatant collection tank 181. The injection of these samples into the rotor 10 is adjusted by controlling the liquid delivery pump 173 with a control device (not shown).

The sample is centrifugally separated by high-speed rotation of the rotor 10, and the supernatant of the separated sample flows through the upper shaft 131 and the drive part 130, flows into the upper connecting pipe 182, passes through a mass flow meter 185, and is collected into the supernatant collection tank 181. In this embodiment, since the sample line is configured such that the sample is injected from the lower side of the rotor 10 and the supernatant is discharged from the upper side, the lower connecting pipe 172 serves as the supply line of the sample, and the upper connecting pipe 182 serves as the discharge line of the supernatant. The lower connecting pipe 172 connects between the sample tank 171 and the lower rotation support part 140, and the liquid delivery pump 173 and a supply-side mass flow meter 175 are provided in the path of the lower connecting pipe 172. The upper connecting pipe 182 connects between the upper shaft 131 of the drive part 130 and the supernatant collection tank 181.

The liquid delivery pump 173 is a sample supply means on which send or stop control is electrically performed by the control device, and is, for example, a fluid pump driven by a motor. The mass flow meter 175 may be, for example, an inline-type Coriolis mass flow meter, and measures the mass flow rate of the sample flowing in the lower connecting pipe 172 to output a signal corresponding to this value to the control device. The mass flow meter 185 measures the mass flow rate of the sample flowing in the upper connecting pipe 182 and outputs a signal corresponding to this value to the control device. The mass flow meter 185 and the mass flow meter 175 may adopt the same measuring device, and their outputs are sent to the control device. The piping method of the lower connecting pipe 172 and the upper connecting pipe 182 that constitute the sample line, the arrangement and connection of the sample tank and the supernatant tank used, etc., may be selected in any manner. Depending on the sample to be centrifugally separated, the sample may also be supplied to the rotor 10 from the upper connecting pipe 182, and the waste liquid may also be collected from the lower connecting pipe 172.

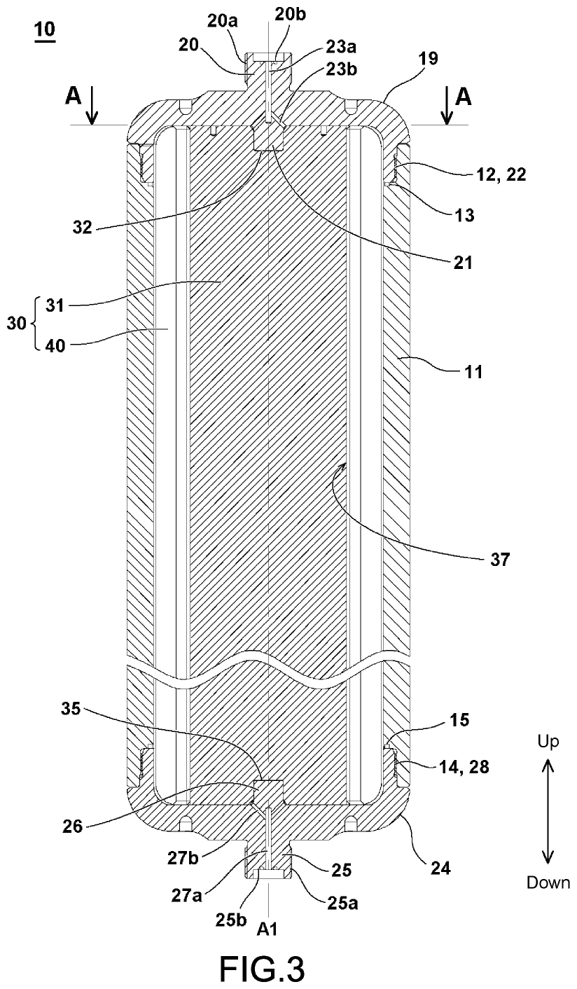

FIG. 3 is a longitudinal sectional view of the rotor 10 shown in FIG. 1. The rotor 10 is mainly composed of a rotor body 11, a core body 31, a fin 40, an upper rotor cover 19, and a lower rotor cover 24. A core 30 in a cylindrical shape is arranged coaxially with a rotation axis A1 on the inner side of the rotor body 11 in a cylindrical shape. The core 30 is configured to be capable of being taken in and out in the axial direction with respect to the rotor body 11, and serves for introducing a sample injected into the rotor body 11 to a high centrifugal field. A female screw part 12 is formed in the vicinity of the upper opening of the rotor body 11, and a male screw part 22 is formed in the vicinity of the opening of the upper rotor cover 19. By screwing the male screw part 22 and the female screw part 12 together, the upper rotor cover 19 is fixed to the rotor body 11. An O-ring 13 is interposed between the upper rotor cover 19 and the upper opening of the rotor body 11. Similarly, a female screw part 14 is formed in the vicinity of the lower opening of the rotor body 11, and a male screw part 28 is formed in the vicinity of the opening of the lower rotor cover 24. By screwing the male screw part 28 and the female screw part 14 together, the lower rotor cover 24 is fixed to the rotor body 11. An O-ring 15 is interposed between the lower rotor cover 24 and the lower opening of the rotor body 11. In this manner, with the upper side and the lower side of the rotor body 11 in a cylindrical shape closed by the rotor covers (19 and 20), sealing is provided between the upper rotor cover 19 and the rotor body 11 and between the lower rotor cover 24 and the rotor body 11.

A protrusion 20 in a cylindrical shape protruding upward is formed on the rotation axis A1 of the upper rotor cover 19. A male screw part 20a is formed on the outer circumferential surface of the protrusion 20, and a flow path 23a extending in the axial direction from the upper surface is formed on the rotation axis A1. By screwing with a female screw formed on the inner circumferential side of the nut 132 of the upper shaft 131, the flow path 23a defines a sample passage that continuously discharges the sample from the rotor 10 to the upper shaft 131. The flow path 23a is opened to a recess 20b formed at the upper rotor cover 19, and the lower side of the flow path 23a is connected to four branch paths 23b (only two are visible in the figure) that branch out in a diagonal radial pattern. The branch paths 23b are opened to a connection part between a fitting hole 32 of the core body 31 and a fitting shaft 21.

A protrusion 25 protruding downward is formed coaxially with the rotation axis A1 at the lower rotor cover 24. A male screw part 25a is formed on the outer circumferential surface of the protrusion 25, and a flow path 27a extending in the axial direction from the lower surface is formed coaxially with the rotation axis A1 in the protrusion 25. By screwing with a female screw formed on the inner circumferential side of the nut 142 of the lower shaft 141, the flow path 27a defines a sample circulation passage that continuously injects the sample from the lower shaft 141 to the rotor 10. The flow path 27a is opened to a recess 25b formed at the lower rotor cover 24, and is connected to a branch path 27b branching into four paths in a diagonal radial pattern to the upper portion, which is an internal space of the rotor 10. The branch path 27b is opened in the vicinity of a connection surface between a fitting hole 35 of the core body 31 and a fitting shaft 26 formed at the lower rotor cover 24.

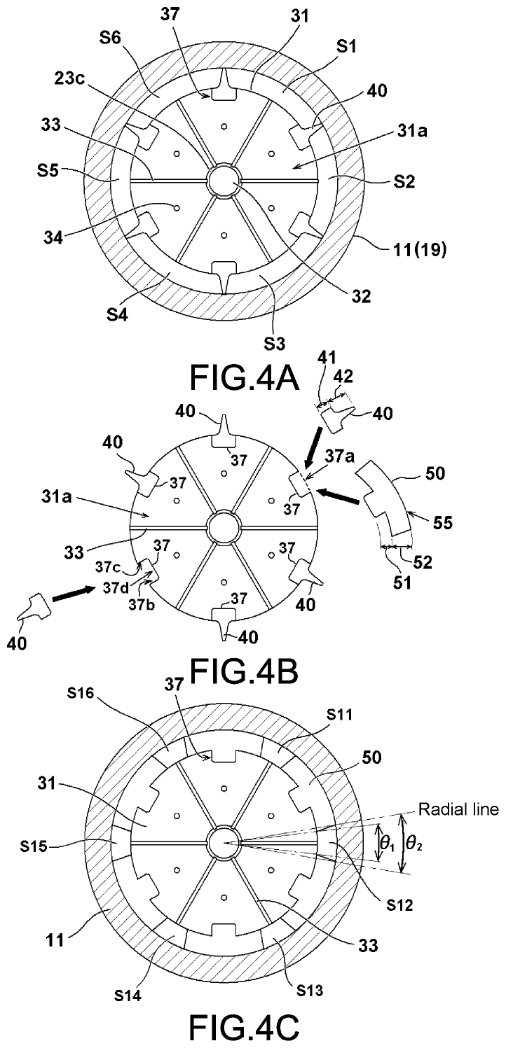

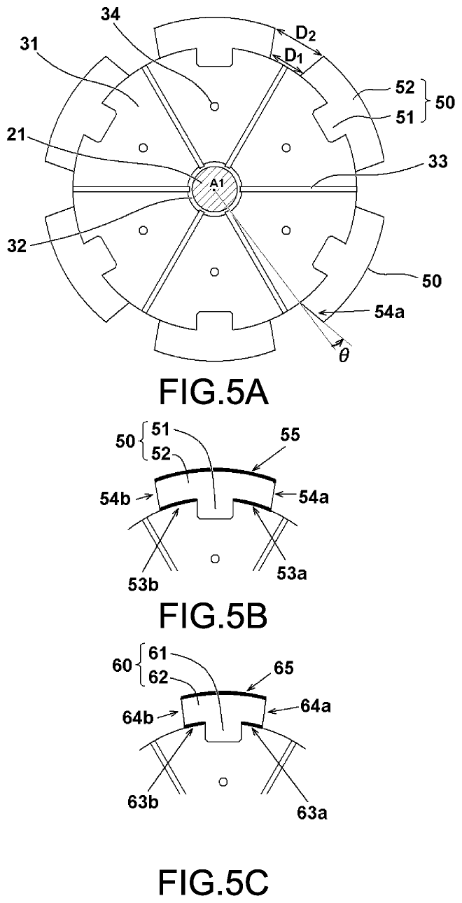

The core 30 is a solid member, and is fixed so as not to rotate relatively by inserting pins (not shown) for fixing the core provided at the lower rotor cover 24 into pin holes 34 of the rotor body. Further, the core 30 functions as a partition member that forms a separation space S used for the centrifugal separation operation in a radially outer portion of the internal space of the rotor body 11, and defines a plurality of separation spaces S1 to S6 (see reference signs in FIG. 4 to be described later) that are partitioned in the circumferential direction. The core 30 of this embodiment is made of synthetic resin, and six fins 40 are mounted to fin mounting grooves 37 formed to recess inward from the outer circumferential surface of the core body 31. The fin mounting groove 37 is formed to be the same as the size of the rotation axis A1 direction of the core 30, is formed continuously from the upper end to the lower end of the core body toward a direction parallel with the rotation axis A1, and a cross-sectional shape in the rotation axis A1 direction is formed with substantially the same cross-sectional shape except in the vicinity of both upper and lower end parts. The shape of the fin 40 will be described later with reference to FIG. 4 and FIG. 5.

FIG. 4 is a cross-sectional view of an A-A part in FIG. 3. At this cross-sectional position, the view corresponds to a top view of the core body 31 and the fin 40. Further, in the A-A part in FIG. 3, the outer circumferential side corresponds to the upper rotor cover 19, but since the cross-sectional shape is the same, for convenience of illustration, it is illustrated that the rotor body 11 is on the outer side of the core body 31. The core 30 is composed of a core body 31 in a cylindrical shape and a plurality of fins 40 that extend to protrude in a radial pattern outward from the core body 31 in the radial direction centered on the rotation axis A1 (central axis). Accordingly, as shown in FIG. 4, six separation spaces S (S1 to S6) separated by the six fins 40 are formed on the inner side of the rotor body 11. A groove part 23c in an annular shape and six guide grooves 33 that extend in a straight line shape toward the radially outer side from the groove part 23c are formed on the upper surface of the core body 31. The guide groove 33 is formed as a recess with a depth substantially equal to the width of the groove on the upper surface 31a. On the outer circumferential side of the groove part 23c, except for the portion where the guide groove 33 is formed, the upper surface 31a of the core 30 is in good contact with the inner wall surface (lower surface) of the upper rotor cover 19, so an elongated flow path is formed by the recess of the guide groove 33 and the lower surface of the upper rotor cover 19. That is, the guide grooves 33 serve as conduits (flow paths) for connecting the vicinity of the upper ends of the separation spaces S1 to S6 from the groove part 23c which forms a donut-shaped space.

The fitting shaft 21 (see FIG. 3) protruding downward is provided on the lower surface side in a region including the rotation axis of the upper rotor cover 19. The fitting hole 32 which fits with the fitting shaft 21 is provided on the upper side of the core body 31, and the fitting shaft 21 and the fitting hole 32 are fitted together. Although not shown herein, six guide grooves 38 similar to the guide grooves 33 are also formed on the lower end surface of the core body 31. Each guide groove 38 has the same shape as on the upper surface 31a of the core body 31 and is connected to the lower end part of the six centrifugal separation spaces SI to S6. The fitting shaft 26 (see FIG. 3) protruding upward is provided on the upper side of the lower rotor cover 24, and fits with the fitting hole 35 (see FIG. 3) formed on the lower side of the core body 31. In this manner, the upper rotor cover 19, the core 30 (core body 31), and the lower rotor cover 24 are fixed to be connected, and the rotor 10 is driven integrally by the drive part 130.

As described above, since the centrifugal separation space S defined by the core 30 and the rotor body 11 is provided with the fins 40 at equal intervals in the circumferential direction (rotation direction), the centrifugal separation space S is divided into a plurality of spaces S1 to S6 to suppress generation of turbulence in the sample centrifugally separated. If the centrifugal separation space S (S1 to S6) was configured as a continuous space, namely a so-called donut-shaped space, the sample would be more likely to circulate in the circumferential direction within the centrifugal separation space S due to acceleration or deceleration during acceleration/deceleration of the rotor 10. To prevent this circulation, the fins 40 are provided at equal intervals in the circumferential direction and divide the centrifugal separation space into six parts S1 to S6.

FIG. 4(B) shows a state in which one of the fin 40 and a fin 50 is attached to the core body 31. The fin mounting grooves 37 are formed at six spots in the circumferential direction of the core body 31. The fin mounting groove 37 is a groove that is recessed in the rotation axis A1 direction from the outer circumferential surface of the core body 31, and is continuously formed from the upper part to the lower part of the core body 31 parallel to the rotation axis A1. The fin mounting groove 37 is formed with two sidewall surfaces 37b and 37c with wall surfaces that are parallel or substantially parallel. A bottom surface 37d is formed on a side of the two sidewall surfaces 37b and 37c close to the rotation axis A1, and the opposite side of the bottom surface 37d is an opening surface 37a of the fin mounting groove 37. When viewed in the circumferential direction centered on the rotation axis A1, the fin mounting groove 37 is formed at a midpoint position of radially outer side openings of two adjacent guide grooves 33. Thus, the quantity (=6) of the guide grooves 33 and the quantity (=6) of the fin mounting grooves 37 are equal. One of the fin 40 and the fin 50 is mounted to the fin mounting groove 37. The fin 40 realizes a core in the same form as a conventional one, and in a state in which the fin 40 is attached to the core body 31, the external shape is the same as the external shape of a core in the conventional form manufactured by integrally molding with the core body. The configuration other than the core 30 in this centrifuge is the same as that of a conventional centrifuge 1 having a core integrated with fins. Thus, the present invention can be realized by changing the integral-type core (not shown) of the conventional centrifuge 1 to the core 30 described above.

The core body 31 is manufactured by integral molding of synthetic resin, for example, manufactured by modified polyphenylene ether (m-PPE). The fin 40 is also formed by integral molding of synthetic resin such as modified polyphenylene ether. The fin 40 has two portions including an attachment part 41 and a protruding part 42. The attachment part 41 is a portion that is fitted into the fin mounting groove 37 of the core body 31, and has a width substantially the same as the circumferential width of the fin mounting groove 37 (but is a width slightly smaller to be capable of being inserted into the fin mounting groove 37). The protruding part 42 is a portion that protrudes to the radially outer side from an outer edge in a cylindrical shape of the core body 31. The cross-sectional shape of the protruding part 42 is a tapered shape in which the thickness in the circumferential direction decreases as it extends from the attachment part 41 toward the tip (radially outer side).

The fin 50 is a fin newly prepared in the embodiment of the present invention, and is similarly formed of an attachment part 51 and a protruding part 52 as in the case of the fin 40. The fin 50 may also be manufactured by integral molding of synthetic resin such as modified polyphenylene ether. The shape of the attachment part 51 is identical to the shape of the attachment part 41 of the fin 40, and is a shape to be entirely inserted into the recess formed by the fin mounting groove 37. The protruding part 52 is a portion that protrudes to the radially outer side from the outer circumferential surface of the core body 31 and the opening surface 37a of the fin mounting groove 37, and has a shape as formed by cutting out a part of the cylindrical centrifugal separation space substantially parallel to the rotation axis A1 by about 20 degrees in angle. The length of the protruding part 52 in the rotation direction (circumferential direction) is formed to be larger than the width of the fin mounting groove 37, and the area of the outer circumferential surface of the fin 50 becomes sufficiently larger than the area of the opening surface 37a of the fin mounting groove 37.

Since a part of the centrifugal separation space is occupied by the protruding parts 52, it is possible to reduce the volume of the centrifugal separation spaces S11 to S16 available. When attaching the fin 50, all the already mounted fins 40 are removed from the core body 31, and the six fins 50 are attached to the removed fin mounting grooves 37. Herein, it is important not to attach different fins to the core body 31 in a mixed manner, but to attach fins of the same size (the fins 40 or the fins 50). This is to equalize the volumes of the six centrifugal separation spaces defined by the fins 40 or 50. The fins 40 or 50 are not fixed using other fixing members such as screws, but the attachment parts 41 and 51 may be simply fitted into the fin mounting grooves 37. Herein, the fins 40 and 50 are formed to an extent that, when mounting the fins 40 and 50 to the fin mounting grooves 37, formation of a gap is avoided as much as possible between the attachment parts 41 and 51 and the fin mounting grooves 37, and only a slight gap that allows for mounting and removal by a manual operation of the user is formed.

The mounting and removal of the fins 40 or the fins 50 are performed when the rotor 10 is disassembled and the core 30 is separated from the rotor body 11. No jigs or tools are required for mounting and removing the fins 40 and 50 to and from the core body 31. Thus, the user can easily attach and detach the fins 40 and 50 during disassembly and cleaning of the rotor 10. Further, that the fins 40 and the fins 50 are of a separable type is advantageous during cleaning of the rotor 10.

FIG. 4(C) is a view showing a state in which the fins 50 are mounted in place of the fins 40, and is a view corresponding to FIG. 4(A). The core body 31 used in FIG. 4(A) and (C) is the same. The outer circumferential surface of the fin 50 is formed as an arc surface having an outer diameter substantially equal to the size (inner diameter) of the inner circumference of the rotor body 11 and is in contact and opposed to the inner circumferential wall surface of the rotor body 11. As can be seen from FIG. 4(C), the volumes of the centrifugal separation spaces S11 to S16 significantly decrease to equal to or less than half of the centrifugal separation spaces S1 to S6 in FIG. 4(A). The size of the protruding part 52 of the fin 50 in the circumferential direction may be set in any manner, and the volumes of the centrifugal separation spaces S11 to S16 are determined by its size.

After one of the fin 40 and the fin 50 is attached, the core body 31 is inserted into the rotor body 11 from the lower or upper opening. Thus, the shape of the fin 50 is determined such that this insertion becomes possible, that is, in a size that allows the outer circumferential surface of the fin 50 to slide against the inner circumferential wall surface of the rotor body 11. Adopting such an assembly method is the same as the disassembly and assembly method of the conventional rotor 10, and is only different in that the core 30 can be further disassembled into the core body 31 and the fins 40 or 50, so it is easy for the user to handle.

As described above, in this embodiment, by mounting the fins 50 in place of the fins 40, it is possible to form the centrifugal separation spaces S11 to S16 having small volumes equal to or less than half of the centrifugal separation spaces S1 to S6 shown in FIG. 4(A). Although the circumferential length of the centrifugal separation spaces S11 to S16 is smaller than that of the centrifugal separation spaces S1 to S6, the centrifugal separation spaces S11 to S16 are consistent with the general centrifugal separation spaces S1 to S6 shown in FIG. 4(A) in that each of the centrifugal separation spaces S11 to S16 is formed on the outer side of the guide grooves 33 formed in a radial pattern in the radial direction, and that the distances of the inner circumferential wall and the outer circumferential wall of the centrifugal separation spaces S11 to S16 from the rotation axis A1 remain the same. In other words, by using the fin 50 obtained by changing the circumferential length of the protruding part of the fin 40, it is possible to change the flow path cross-sectional area without changing the radial dimension of the separation spaces S11 to S16 (centrifugal field). Thus, in centrifugal separation operation using the fins 40 and the centrifugal separation space using the fins 50, if the rotational speed is the same, since the centrifugal acceleration applied to the sample is the same, it is possible to quickly optimize the operating conditions using a small amount of sample without changing the separation conditions according to the sample volume. The sidewalls viewed in the circumferential direction of the fin 50 is formed such that an angle θ₁ occupied on the inner circumferential side is smaller than an angle θ₂ occupied on the outer side (55).

FIG. 5(A) is a top view showing a state in which the fins 50 according to this embodiment are attached to the core body 31 of this embodiment, and (B) is a partial view of (A). End surfaces 54a and 54b, which form sidewalls viewed in the circumferential direction of the fin 50, form an angle θ₁ of 15 degrees occupying the circumferential direction on the inner circumferential side and an angle θ₂ of 20 degrees occupying the circumferential direction on the outer circumferential side. In other words, the centrifugal separation spaces S11 to S16 are configured in a shape such that a distance D1 on the inner circumferential side is smaller than a distance D2 on the outer circumferential side, and are formed such that the centrifugal separation space spreads in a horizontal plane from the inner side toward the outer side. This spreading shape of the centrifugal separation spaces S11 to S16 is advantageous for separating most samples. The selection of the sizes of D₁ and D₂ may be performed in any manner, and although it is preferable that D₁≤D₂, depending on the sample to be centrifugally separated, it may be more appropriate to form the sizes such that D₁>D₂ in some cases.

The fin 50 shown in FIG. 5(B) is a fin adapted for a small volume. The outer circumferential surface 55 of the fin 50 is similar in shape to the inner circumferential wall of the rotor body 11. The inner circumferential surface of the fin 50 is formed with an inner circumferential surface 53a on one side in the rotation direction and an inner circumferential surface 53b on the other side that sandwich the protruding part 52. The inner circumferential surfaces 53a and 53d are formed in the same shape as the outer circumferential surface of the core body 31, that is, as an arc surface, to be capable of in close contact with the outer circumferential surface of the core body 31. The end surfaces 54a and 54b of the fin 50 do not have a shape extending along a vertical plane passing through the rotation axis A1, but are configured with a predetermined angle θ (see FIG. 5(A)) with the outer circumferential side spreading.

A fin 60 shown in FIG. 5(C) is a fin adapted for a medium volume, which is a volume smaller than the standard fin 40 and larger than the small-volume fin 50. The shape of the fin 60 is similar to the shape of the fin 50, is formed of an attachment part 61 and a protruding part 62, and a length occupying the circumferential direction of the protruding part 62 is different from that of the protruding part 52. The shape of an outer circumferential surface 65 of the fin 60 is similar to the shape of the inner circumferential wall of the rotor body 11. Inner circumferential surfaces 63a and 63d of the fin 60 are configured to have the same shape as the outer circumferential surface of the core body 31 to be capable of being in close contact with the outer circumferential surface of the core body 31.

As described above, the fins 50 and 60 are formed to include the attachment parts 51 and 61 in a shape corresponding to the fin mounting groove 37, and the protruding parts 52 and 62 which protrude to the radially outer side from the fin mounting groove 37. By forming the protruding parts 52 and 62 to extend to both sides in the radial direction of the rotor 10 beyond the forming range of the fin mounting groove 37, it becomes possible to change the volume of the centrifugal separation space S between the core body 31 and the rotor body 11. Although two examples of the fins 50 and 60 in FIG. 5(B) and (C) have been described in this embodiment, it is also possible to define a centrifugal separation space further smaller than or further larger than the fin 50 by further extending or shortening the circumferential direction of the protruding part 52 of the fin 50 shown in FIG. 5(B).

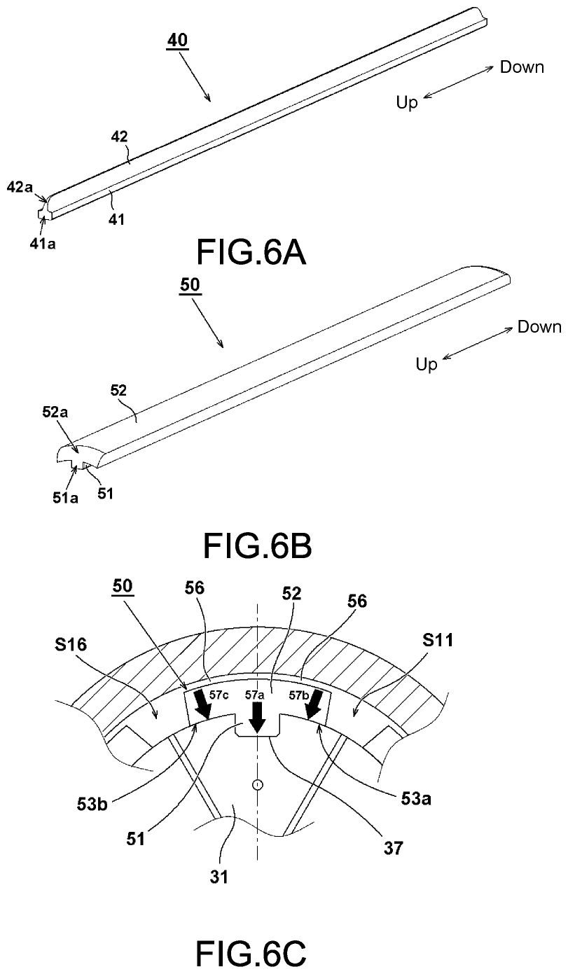

FIG. 6(A) is a perspective view showing the overall shape of the standard fin 40 shown in FIG. 4(A). The fin 40 has a length corresponding to the core body 31 in the rotation axis A1 direction (up-down direction), and is formed with substantially the same cross-sectional shape from the upper end to the lower end except for both the upper and lower end parts. An upper end surface 41a of the attachment part 41 is similarly flat as the upper surface 31a (see FIG. 4) of the core body 31, and is formed on a surface perpendicular to the rotation axis A1. The upper end of the protruding part 42 is formed to become a curved surface 42a that lowers as it extends toward the radially outer side. In other words, the curved surface 42a is formed in a shape extending along the inner wall surface of the upper rotor cover 19. The fin 40 has an up-down symmetrical shape and may be mounted with either end part on the upper side of the core body 31. Thus, although not visible in the figure, the lower end surface of the attachment part 41 and the lower end surface of the protruding part 42 are formed in an up-down symmetrical shape with respect to the upper end surface 41a and the curved surface 42a.

FIG. 6(B) is a perspective view showing the overall shape of the fin 50 for forming the small-volume centrifugal separation spaces S11 to S16 shown in FIG. 4(C). The length of the fin 50 in the rotation axis A1 direction (up-down direction) is the same as that of the fin 50 and is equal to the up-down length of the core body 31. The cross-sectional shape of the fin 50 perpendicular to the rotation axis A1 is substantially the same from the upper end to the lower end except for both the upper and lower end parts. An upper end surface 51a of the attachment part 51 is similarly flat as the upper surface 31a (see FIG. 4) of the core body 31, and is formed on a surface perpendicular to the rotation axis A1. An upper end part 52a of the protruding part 52 is formed as a curved surface 52a that lowers as it extends toward the radially outer side along the inner wall surface of the upper rotor cover 19. The fin 50 has an up-down symmetrical shape and may be mounted with either end part on the upper side of the core body 31. Thus, although not visible in the figure, the lower end surface of the attachment part 51 and the lower end surface of the protruding part 52 are formed in an up-down symmetrical shape with respect to the upper end surface 51a and the curved surface 52a.

FIG. 6(C) is a horizontal sectional view for illustrating the state of the fin 50 for a small volume when the rotor 10 is rotated at high speed. At the start of rotation in the centrifugal separation operation, a density gradient layer is formed in the centrifugal separation spaces S11 to S16, and the sample, which is the separation target, is further injected while rotating the rotor 10, so eventually the centrifugal separation spaces S11 to S16 are full of the sample. When the rotor 10 is rotated at high speed, a strong centrifugal load is applied to the rotor body 11, the core body 31, and the fin 50, respectively. At this time, in the sample, components with large densities are separated to the outer circumferential side of the centrifugal separation spaces S11 to S16, and light components move to the inner circumferential side of the centrifugal separation spaces S11 to S16. During such centrifugal separation of the sample, whether the fin 50 moves to the outer side or the inner side is determined by its relative relationship with the density of the sample filled in the centrifugal separation spaces S11 to S16. In other words, during rotation of the rotor 10, depending on the relationship between the density of the sample supplied into the rotor 10 and the density of the fin 50, the fin 50 leans (moves) toward one of the inner side and the outer side.

In this embodiment, the fin 50 is formed to be lighter than the density of the density gradient liquid (generally a density of about 1 to 1.22) and the maximum density among components contained in the sample. By configuring the density of the fin 50 in a range (herein, a specific gravity less than 1.20), during high-speed rotation of the rotor 10, relative forces such as arrows 57a to 57b are applied from the sample to the protruding part 52 of the fin 50, and the fin 50 is pushed against the core body 31 on the inner side. Further, during high-speed rotation of the rotor 10, the rotor body 11 slightly expands outward due to strong centrifugal force, and thus a gap 56 is created between the protruding part 52 of the fin 50 and the inner circumferential surface of the rotor body 11, but this embodiment allows for this state. When centrifugal loads such as the arrows 57a to 57b are applied, since the outer circumferential surface of the core body 31 is in close contact with the inner circumferential surfaces 53a and 53b of the protruding part 52, it is possible to suppress entrance of the sample into a gap between the fin mounting groove 37 and the attachment part 51. If a gap 56 is created during high-speed rotation of the rotor 10. components separated thereto may also enter. In FIG. 6(C), the actual gap 56 is generally difficult to confirm visually, so the gap in the radial direction has been schematically illustrated as enlarged for understanding of the invention.

As described above, in this embodiment, by using the fin 40 and the fin 50 mounted to the core body 31 with changed circumferential widths, it is possible to change the flow path cross- sectional area without changing the radial dimensions of the centrifugal separation spaces (centrifugal fields) S1 to S6 or S11 to S16. Thus, since a test operation may be performed using a small amount of sample created to determine operating conditions, an optimization operation of centrifugal operating conditions can be quickly performed. Furthermore, since the operating conditions can be determined with a small amount of sample, the sample to be discarded after the test operation is small. In addition, by preparing a plurality of fins with different circumferential widths of the protruding part, a rotor 10 having centrifugal separation spaces of multiple stages can be realized.

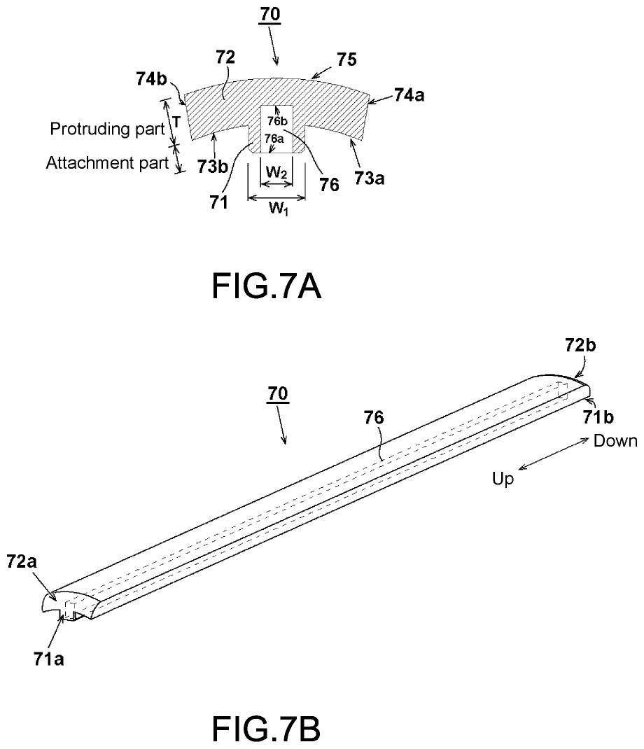

Next, a modification example of the present invention will be described with reference to FIG. 7. FIG. 7 is a view showing a fin 70 for a small volume according to a first modification example of this embodiment, and (A) is a horizontal sectional view. As described above, by configuring the density (unit: g/cm³) of the fin 70 within a predetermined range compared to the density of the density gradient liquid and the sample, it is possible to operate in a manner as the fin 50 which is in close contact with the core body 31 on the inner side during centrifugal separation, as indicated by the arrows 57a to 57c in FIG. 6(C). To ensure this operation, it may be important to configure the specific gravity of the entirety of the fin 50 to be smaller than the inherent density of the material constituting it. The fin 70 in FIG. 7 is similar to the fins 40, 50, and 60 in that it is manufactured by integral molding of synthetic resin, but a part of the internal space of the fin 70 is formed with a cavity 76 such that the specific gravity of the fin 70 mounted to the core body 31 becomes smaller than that of the fin 50. The external shapes of the fin 70, i.e., a size of an outer circumferential surface 75, a thickness T of a protruding part 72, sizes of inner circumferential surfaces 73a and 73b, positions of end surfaces 74a and 74b, inclination angles of the end surfaces 74a and 74b with respect to tangents, etc. are the same as those of the fin 50.

The cavity 76 of the fin 70 is formed to be in contact with the outer surface of the fin 50 serving as reference. Herein, the cavity 76 extends to the radially outer side from the inner circumferential surface of the attachment part 71, and a bottom part 76b viewed from an opening 76a is located inside the protruding part 72. By forming the cavity 76 to reach not only the attachment part 71 but also to the protruding part 72 in this manner, it is possible to lighten the fin 70 by the amount of material occupied by the cavity 76, and it is possible to reduce the total mass with respect to the volume occupied by the fin 70, i.e., reducing its specific gravity. The cavity 76 is formed to have a width W₂ with respect to a width W₁ (where W₂<W₁) of the attachment part 71 when viewed in the circumferential direction. Since the opening 76a of the cavity 76 is closed by the fin mounting groove 37 of the core body 31. it is possible to prevent the sample from flowing inside. Further, during rotation of the rotor 10, as shown in FIG. 6(C), since the fin 70 is urged toward the radially inner side, it is possible to prevent the possibility of inflow of the sample into the cavity 76.

FIG. 7(B) is a perspective view showing the entirety of the fin 70. The cavity 76 has a shape that is continuous in the axial direction, but is not formed in the vicinity of both the upper and lower end parts, i.e., not formed in the vicinity of an attachment part upper surface 71a and not formed in the vicinity of an attachment part lower surface 71b. Similarly, the cavity 76 is not formed in the vicinity of a protruding part upper surface 72a and in the vicinity of the protruding part upper surface 72b. Thus, with the fin 70 mounted, the core body 31 is in a state in which the cavity 76 is not exposed to outside. Such formation of the cavity 76 can be easily manufactured by injection molding of the fin 70.

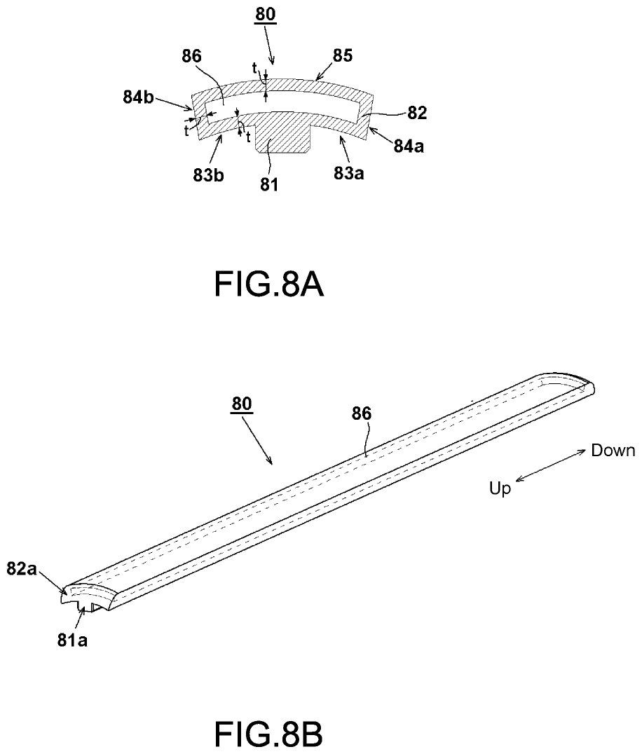

FIG. 8 is a view showing a fin 80 for a small volume according to a second modification example of this embodiment, and (A) is a horizontal sectional view. The fin 80 is an integral molding product of synthetic resin, and a cavity 86 is formed inside. The cavity 86 is formed inside a protruding part 82 during injection molding, and is formed such that air and liquid cannot exit to and enter from outside. The cavity 86 is not arranged inside an attachment part 81. The manufacturing of the cavity 86 may be performed using conventional blow molding technology of synthetic resin, and a thickness t between the cavity 86 and an outer circumferential surface 85, a thickness t between the cavity 86 and end surfaces 84a and 84b, and a thickness t between the cavity 86 and inner circumferential surfaces 83a and 83b are formed to be substantially constant. Since the attachment part 82 is formed solid rather than hollow, it is possible to form the center of gravity of the fin 80 close to the rotation axis A1 compared to the fin 70 shown in FIG. 7, which is advantageous in the centrifugal separation operation. In this modification example, since the cavity 86 of the fin 80 is not exposed to outside, when removing and cleaning the fin 80, it is not required to be aware of the presence of the cavity 86, and similarly, cleaning can be easily performed as with the fin 50.

FIG. 8(B) is a perspective view showing the entirety of the fin 80. The cavity 86 has a shape that is continuous from the vicinity of the upper end to the vicinity of the lower end in the rotation axis A1 direction. Since wall surfaces are formed at a protruding part upper surface 82a and a protruding part lower surface 82b and the cavity 86 is closed, the air inside the cavity 86 does not communicate with the outside.

According to this embodiment, it is possible to change the flow path area by simply replacing the blade part (the fins 50, 60, and 70) without changing the radial dimension of the body (core body 31) of the core 30. Although fins made of synthetic resin have been described in the embodiments of the present invention, the fins are not only made of synthetic resin, but may also be formed by integral molding of metal. In a continuous centrifugal separator, steam sterilization may be used in a washing and disinfection process of the rotor 10 depending on the sample to be separated. In steam sterilization, high-temperature steam is flowed into the rotor 10, so it may be preferable to manufacture with metal such as titanium rather than synthetic resin. In that case, the fins 50, 60, and 70 and the core body 31 may both be manufactured with metal.

### Embodiment 2

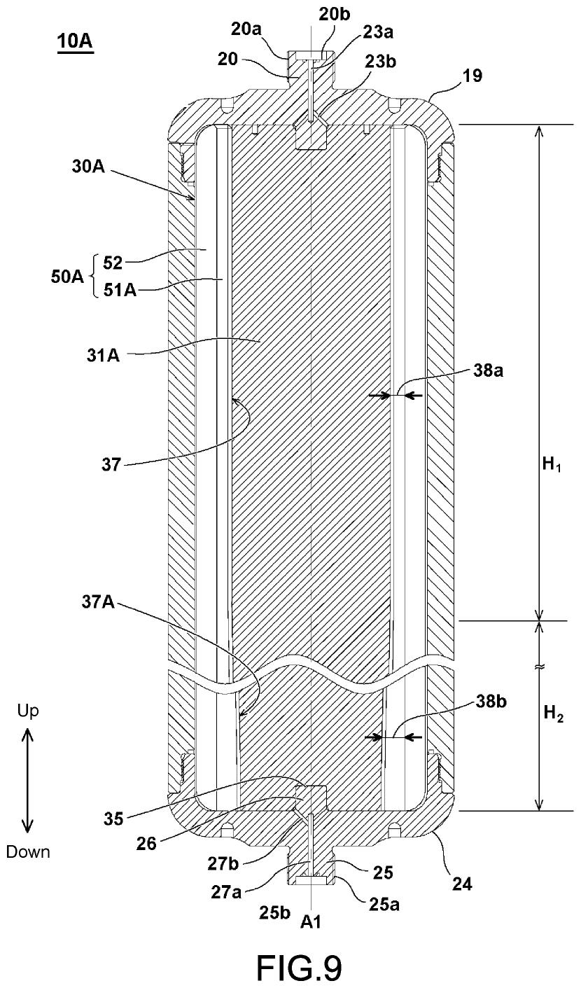

Next, a fin 50A according to a second embodiment of the present invention will be described with reference to FIG. 9. FIG. 9 is a vertical sectional view of a rotor 10A according to the second embodiment of the present invention. The rotor 10A has a rotor body 11, an upper rotor cover 19, and a lower rotor cover 24, and a core 30A is accommodated inside them. The core 30A is composed of a core body 31A and fins 50A. Fin mounting grooves 37 and 37A are continuously formed from the upper end to the lower end over the rotation axis A1 direction (up-down direction) on the outer circumferential surface of the core body 31. Herein, the shape of the fin mounting groove 37 is not the same in the rotation axis A1 direction. In a lower predetermined range (a portion of a height H₂) of the core body 30A, a depth 38b of the groove (=a distance from the outer circumferential edge of the core body to the inner circumferential surface (bottom surface) of the fin mounting groove 37) is formed to gradually increase compared to the fin mounting groove 37 of the first embodiment. The upper rotor cover 19, the rotor body 11. and the lower rotor cover 24 are the same as those in the first embodiment shown in FIG. 3, and the same components are used. In an upper range of H₁ of the core body 31A, a depth 38a of the groove (=depth of the groove of the fin mounting groove 37 from the outer circumferential edge of the core body) of the fin mounting groove 37 is constant. On the other hand, in the lower predetermined range (referred to as a “tapered shape part” in this specification) of H₂ of the core body 30A, the depth 38b of the groove of the fin mounting groove 37A is formed to gradually increase as it goes from the upper end to the lower end of the tapered shape part. The shape of the fin 50A mounted to the core body 31A is formed to match the shape of the fin mounting grooves 37 and 37A.

In the portion indicated by the height H₁ on the upper side, the fin 50A has a cross-sectional shape perpendicular to the rotation axis A1 that is the same as the cross-sectional shape of the fin 50 shown in FIG. 6(B). However, in the cross-sectional shape of the tapered shape part indicated by the height H₂ on the lower side, although the shape of the protruding part 52 is the same, the shape of the attachment part 51A extends in a direction perpendicular to the rotation axis A1 according to the depth 38b of the groove of the fin mounting groove 37A. In this manner, by forming the fin mounting groove 37A in a tapered shape and configuring the fin 50A in a shape corresponding thereto, in a state in which the core body 31 is provided in the rotor body 11 and the lower rotor cover 24 is removed, it is possible to mount the fin 50A by moving the fin 50A upward in the rotation axis A1 direction from below against the fin mounting groove 37. At this time, with the upper end of the fin 50A abutting against the upper rotor cover 19, the position of the fin 50A with respect to the core body 31 in the up-down direction is determined. Similarly, when removing the fin 50A mounted on the core body 31, the removal can be performed by pulling out the fin 50A downward from the core body 31. In the second embodiment, it becomes particularly easy to mount the fin 50A to the core body 31 from below or to remove the fin 50A downward from the core body 31. In particular, when removing the fin 50A, the removal can not only be performed in a completely disassembled state of the rotor 10, but it also becomes possible to remove the six fins 50A in a partially disassembled state in which only the lower rotor cover 24 of the removed rotor 10 is removed.

Although the present invention has been described based on the embodiments above, the present invention is not limited to the above-described embodiments, and various changes may be made within the scope without departing from the spirit thereof. For example, the fins 40, 50, 60, 70, and 80 may be fixed to the core body 31 with screws. Furthermore, as long as the position of the center of gravity of the rotor 10 is positioned on the rotation axis, the fin shape may be configured such that the centrifugal separation space can be changed from six sections to three sections or two sections. Furthermore, it is possible to use a combination of two types of the fins 40, 50, 60, 70, and 80 as needed, but when various fins are attached to the rotor body 11 at this time, it is important to arrange the fins rotationally symmetrically such that the position of the center of gravity is located on the rotation axis.

### REFERENCE SIGNS LIST

1 . . . Centrifuge, 10, 10A . . . Rotor, 11 . . . Rotor body, 12, 14 . . . Female screw part, 13, 15 . . . O-ring, 19 . . . Upper rotor cover, 20 . . . Protrusion, 20a . . . Male screw part, 20b . . . Recess, 21 . . . Fitting shaft, 22 . . . Male screw part, 23a . . . Flow path, 23b . . . Branch path, 23c . . . Groove part, 24 . . . Lower rotor cover, 25 . . . Protrusion, 25a . . . Male screw part, 25b. . . . Recess, 26 . . . Fitting shaft, 27a . . . Flow path, 27b . . . Branch path, 28 . . . Male screw part, 30, 30A . . . Core, 31, 31A . . . Core body, 31a . . . Upper surface (of core body), 32 . . . Fitting hole, 33 . . . Guide groove, 34 . . . Pin hole, 35 . . . Fitting hole, 37, 37A . . . Fin mounting groove, 37a . . . Opening surface, 37b, 37c . . . Sidewall surface, 37d . . . Bottom surface, 38 . . . Guide groove, 38 . . . Depth (of fin mounting groove), 40 . . . Fin, 41 . . . Attachment part, 41a . . . Upper end surface (of attachment part), 42 . . . Protruding part, 42a . . . Curved surface, 50, 50A . . . Fin, 51 . . . Attachment part, 51a . . . Attachment part upper end surface, 52 . . . Protruding part, 52a . . . Upper end part, 53a, 53b . . . Inner circumferential surface, 54a, 54b . . . End surface, 55 . . . Outer circumferential surface, 56 . . . Gap, 57a to 57c . . . Centrifugal load, 60 . . . Fin, 61 . . . Attachment part, 62 . . . Protruding part, 63a, 63b . . . Inner circumferential surface, 64a, 64b. . . . End surface, 65 . . . Outer circumferential surface, 70 . . . Fin, 71 . . . Attachment part, 71a. . . . Attachment part upper end surface, 71b . . . Attachment part lower end surface, 72 . . . Protruding part, 72a . . . Protruding part upper surface, 73a, 73b . . . Inner circumferential surface, 74a, 74b . . . End surface, 75 . . . Outer circumferential surface, 76 . . . Cavity, 76a . . . Opening, 76b . . . Bottom part, 80 . . . Fin, 81 . . . Attachment part, 82 . . . Protruding part, 82a . . . Protruding part upper surface, 82b . . . Protruding part lower surface, 84a, 84b . . . End surface, 85 . . . Outer circumferential surface, 86 . . . Cavity, 100 . . . Centrifugal separation part, 101 . . . Chamber, 110 . . . Base, 111 . . . Bolt, 112 . . . Bolt, 130 . . . Drive part, 131 . . . Upper shaft, 132 . . . Nut, 140 . . . Lower rotation support part, 140a . . . Nut, 141 . . . Lower shaft, 142 . . . Nut, 160 . . . Lift, 161 . . . Arm, 171 . . . Sample tank, 172 . . . Lower connecting pipe, 173 . . . Liquid delivery pump, 175 . . . Mass flow meter, 181 . . . Supernatant collection tank, 182 . . . Upper connecting pipe, 185 . . . Mass flow meter, 200 . . . Control device part, 205 . . . Operation panel, 250 . . . Piping group, 311 . . . Rotor body, 331 . . . Core body, 337 . . . Fin mounting groove, 340 . . . Fin, 341 . . . Fin base part, 342 . . . Fin tip part, 345 . . . Movable range, A1 . . . Rotation axis, S, S1 to S6 . . . Separation space (general), S11 to S16 . . . Separation space (reduced)

1. A rotor, which is a rotor for a centrifuge, the rotor comprising:
a core comprising a core body in a columnar shape and a plurality of fins mounted to the core body to protrude in a radial pattern from an outer circumferential surface of the core body; and
a rotor body in a tubular shape that surrounds the core, wherein
the rotor is configured such that a sample is flowed to the core body and inside the rotor body between both end sides in a direction of a rotation axis, and the rotor rotates around the rotation axis, wherein
the fin is capable of being attached and detached with respect to the core body,
as the fin, a plurality of types of fins that have different circumferential widths of a portion protruding to a radially outer side from the outer circumferential surface of the core body are prepared, and
a volume of a centrifugal separation space defined between the core body and the rotor body is changeable by selecting any one of the plurality of types of fins and mounting the fins to the core body.

2. The rotor according to claim 1, wherein
the core body has a cylindrical shape, and a plurality of fin mounting grooves are formed at equal intervals in a circumferential direction on the outer circumferential surface of the core body,
the fin mounting groove is continuously formed from an upper end to a lower end of the core body in a direction parallel to the rotation axis of the rotor,
the fin is formed of an attachment part having a shape corresponding to the fin mounting groove and a protruding part protruding to the radially outer side from an opening surface of the fin mounting groove, and
a circumferential width of the protruding part is formed to be larger than a width of the fin mounting groove.

3. The rotor according to claim 2, wherein the protruding part is formed with an inner circumferential surface in contact with the outer circumferential surface of the core body and an outer circumferential surface in contact with an inner circumferential surface of the rotor body, and an area of the outer circumferential surface of each of the fins is larger than an opening area of the fin mounting groove.

4. The rotor according to claim 3, wherein
the sample to be centrifugally separated is injected into the rotor body from one side in the direction of the rotation axis and discharged from another side in the direction of the rotation axis during rotation of the rotor, and
the fins and the core body are removable from the rotor body during disassembly of the rotor.

5. The rotor according to claim 1, wherein
a radial distance of a space, which is a flow path, between inside of the rotor body and the core is constant regardless of selection of the fin.

6. The rotor according to claim 4, wherein
the core body and the fin are made of synthetic resin or metal, and a specific gravity of the fin is configured to be smaller than a specific gravity of the core body.

7. The rotor according to claim 6, wherein
a density of the fin is less than 1.2 g/cm³, and
upon performing centrifugal separation while flowing the sample into the rotor, the fin moves in a direction approaching the rotation axis due to a density difference with respect to the sample.

8. A rotor in a centrifuge, the centrifuge comprising:
the rotor in a cylindrical shape for separating a sample; a centrifuge chamber in which the rotor is accommodated; and
a drive device that rotates the rotor; and a sample line that continuously supplies and discharges the sample to and from the rotor during rotation of the rotor, wherein
the rotor is composed of:
a rotor body in a cylindrical shape;
a core body that forms a path of the sample by being arranged in the rotor body; and
a fin capable of being attached to and detached from the core body to divide an inside of the rotor body into a plurality of spaces to separate the sample, wherein
the core body is formed with a fin mounting groove for attaching the fin, and
the fin is formed to comprise an attachment part in a shape corresponding to the fin mounting groove and a protruding part protruding to a radially outer side from the fin mounting groove, and a volume of a centrifugal separation space between the core body and the rotor body is changeable by extending the protruding part in a circumferential direction of the rotor beyond a forming range of the fin mounting groove.

9. The rotor according to claim 8, wherein
the protruding part of the fin comprises an arc surface having an outer surface with an outer diameter substantially equal to an inner diameter of the rotor body, an inner surface of the protruding part is formed as an arc surface in contact with an outer surface of the core body, and a density of the fin is configured to be smaller than a density of the core body.

10. A centrifuge comprising:
the rotor according to claim 1; and
a drive part that drives the rotor.
